(19) United States
(12) Patent Application Publication
(10) Pub. No.: US 2017/0329863 A1
(43) Pub. Date: Nov. 16, 2017

(54) Methods and Systems for Tagging Documents and for Compressing Tagged Documents

(71) Applicant: Open Access Technologies, Inc., Nashua, NH (US)

(72) Inventors: Jonathan Brett Metz, Washington, DC (US); Michael G. Paciello, Hudson, NH (US); Georges Grinstein, Hadley, MA (US); Joseph S. Stubblefield, Dunstable, MA (US); Franck Kamayou, Chelmsford, MA (US)

(21) Appl. No.: 15/594,972

(22) Filed: May 15, 2017

Related U.S. Application Data
(60) Provisional application No. 62/336,993, filed on May 16, 2016.

(51) Int. Cl. G06F 17/30; G06F 17/22; G06F 3/12

(52) U.S. Cl. CPC G06F 17/30914; G06F 17/2247; G06F 3/1246; G06F 3/1248; G06F 17/2235

(57) ABSTRACT

A method for generating a document tag structure providing a human-comprehensible description of document contents, the description processable by assistive technology, includes identifying, by a document tagger executing on a computing device, a first object in a document. The method includes generating, by the document tagger, a tag structure in the document, the tag structure including a first tag associated with the first object. The method includes identifying, by the document tagger, a second object in the document. The method includes inserting, by the document tagger, a second tag associated with the second object into the tag structure in an order corresponding to an order of visual appearance of the first object and the second object in the document, wherein inserting the second tag results in generation of a modified tag structure providing a description, processable by assistive technology, of at least one item of content in the document.

### CROSS-REFERENCE TO RELATED APPLICATIONS

This application claims priority from U.S. Provisional Patent Application Ser. No. 62/336,993, filed on May 16, 2016, entitled, “Methods and Systems for Tagging Documents and for Compressing Tagged Documents,” which is hereby incorporated by reference.

### BACKGROUND

The disclosure relates to tagged documents. More particularly, the methods and systems described herein relate to functionality for tagging documents and for compressing tagged documents.

The Portable Document Format (PDF) is a universal document file format for electronic images of text, graphics, or both, and provides a universal document file that enables the exchange of electronic documents. PDF documents may include tags describing various sections of the documents. However, including such tags typically renders the tagged document much larger than untagged documents. Conventional systems do not typically leverage analysis of objects embedded within the PDF documents to provide compression, relying instead on conventional, file-level compression of the PDF documents. Furthermore, conventional systems for generating tags and tag structures in the first instance do not typically provide tag structures enabling human comprehension (e.g., for users with disabilities) or support for assistive technologies in accordance with accessibility guidelines and standards.

### BRIEF SUMMARY

In one aspect, a method for generating a document tag structure providing a human-comprehensible description of document contents, the description processable by assistive technology, includes identifying, by a document tagger executing on a computing device, a first object in a document. The method includes generating, by the document tagger, a tag structure in the document, the tag structure including a first tag associated with the first object. The method includes identifying, by the document tagger, a second object in the document. The method includes inserting, by the document tagger, a second tag associated with the second object into the tag structure in an order corresponding to an order of visual appearance of the first object and the second object in the document, wherein inserting the second tag results in generation of a modified tag structure providing a human-comprehensible description of at least one item of content in the document, the description processable by assistive technology.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2 is a block diagram depicting an embodiment of a system for generating and compressing tagged documents;

FIG. 3 is a flow diagram depicting an embodiment of a method for generating tagged documents;

FIG. 4 is a flow diagram depicting an embodiment of a method for compressing tagged document;

FIG. 5 is a flow diagram depicting an embodiment of a method for optimizing a tagged document for compliance with at least one of a portable document format (PDF) standard and an accessibility standard; and

FIG. 6 is a flow diagram depicting an embodiment of a method for optimizing a tagged document for compliance with at least one of a portable document format (PDF) standard and an accessibility standard.

### DETAILED DESCRIPTION

The methods and systems described herein may provide new and inventive techniques for creating, optimizing, and compressing documents that are processable by assistive technologies, including, without limitation, screen readers, text-to-speech applications, Braille terminals, screen magnification applications, and puff-sip navigation switches.

In some embodiments, the methods and systems described herein provide new techniques for generating and compressing tagged documents that are in compliance with accessibility standards. The methods and systems described herein may leverage analysis of a visual order of objects embedded within a document to generate a tag structure providing a human-comprehensible description of the contents of the document. The methods and systems described herein may leverage analysis of a visual order of objects embedded within a document to generate a tag structure providing a description that is processable by at least one type of assistive technology. The methods and systems described herein may leverage analyses of objects embedded within a tagged document to compress the tagged document. The methods and systems described herein may provide functionality for real-time compression of documents, including those documents containing embedded visualizations or images of visualizations. The methods and systems described herein, therefore, provide new techniques and data structures for generating documents compliant with accessibility standards and processable by assistive devices to, for example, improve access for those with disabilities including visual impairments, motor/mobility impairments, learning disabilities, and cognitive limitations.

In some embodiments, the methods and systems described herein provide functionality for compressing tagged documents and for optimizing a tagged document for compliance with at least one of a portable document format (PDF) standard and an accessibility standard. Before describing these methods and systems in detail, however, a description is provided of a network in which such methods and systems may be implemented.

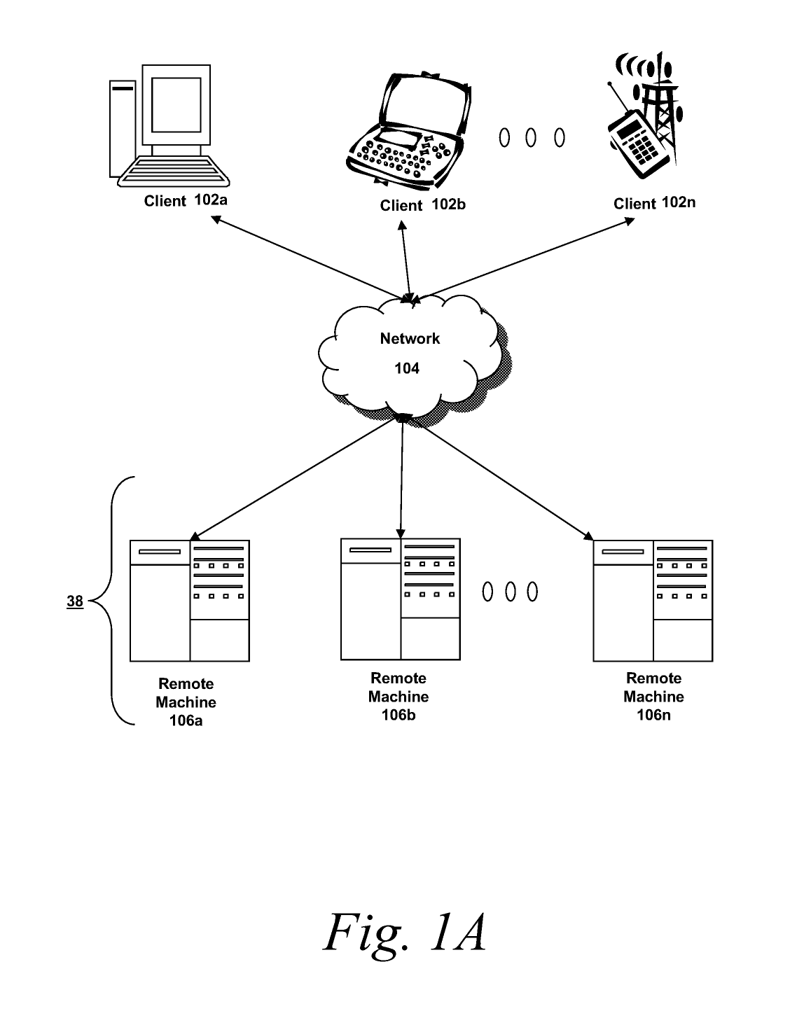

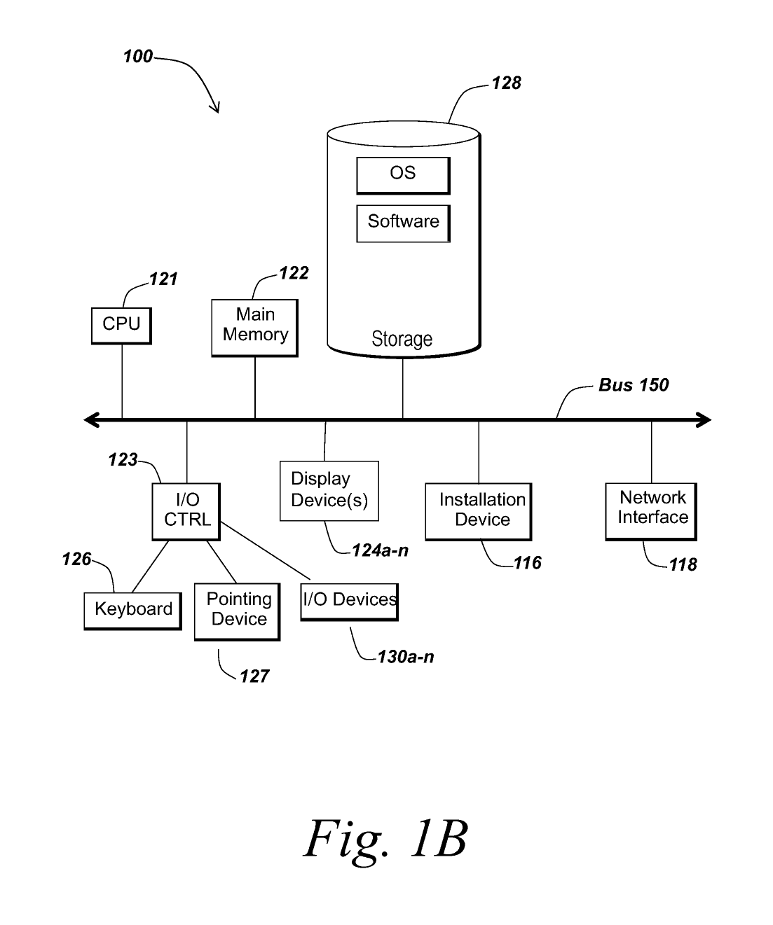

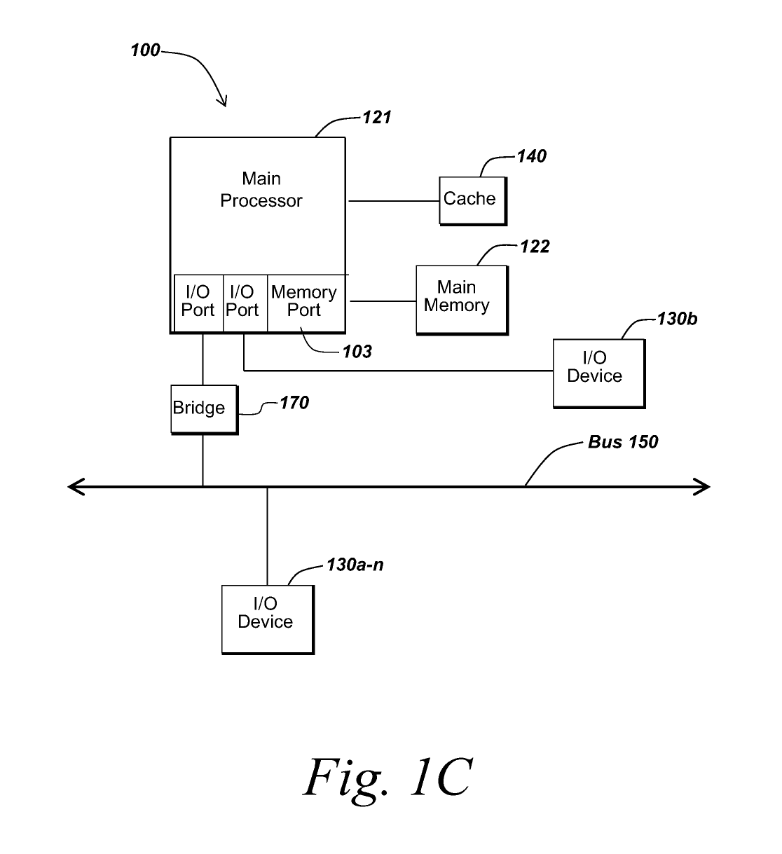

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices (including tablets and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on a client 102.

In one embodiment, a computing device 106 provides the functionality of a web server. In some embodiments, a web server 106 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. Furthermore, an I/O device may also provide storage and/or an installation medium 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 100 may provide functionality for installing software over a network 104. The computing device 100 may further comprise a storage device, such as one or more hard disk drives or redundant arrays of independent disks, for storing an operating system and other software. Alternatively, the computing device 100 may rely on memory chips for storage instead of hard disks.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, each of which may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SO/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, WINDOWS VISTA, and WINDOWS 10, all of which are manufactured by Microsoft Corporation of Redmond, Wash.; MAC OS manufactured by Apple Inc. of Cupertino, Calif.; OS/2 manufactured by International Business Machines of Armonk, N.Y.; Red Hat Enterprise Linux, a Linus-variant operating system distributed by Red Hat, Inc. of Raleigh, N.C.; Ubuntu, a freely-available operating system distributed by Canonical Ltd. of London, England; or any type and/or form of a UNIX operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments, the computing device 100 is a mobile device, such as a JAVA-enabled cellular telephone/smartphone or personal digital assistant (PDA). The computing device 100 may be a mobile device such as those manufactured, by way of example and without limitation, by Apple Inc. of Cupertino, Calif.; Google/Motorola Div. of Ft. Worth, Tex.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada. In yet other embodiments, the computing device 100 is a smartphone, POCKET PC, POCKET PC PHONE, or other portable mobile device supporting Microsoft Windows Mobile Software.

In some embodiments, the computing device 100 is a digital audio player. In one of these embodiments, the computing device 100 is a digital audio player such as the Apple IPOD, IPOD TOUCH, IPOD NANO, and IPOD SHUFFLE lines of devices manufactured by Apple Inc. In another of these embodiments, the digital audio player may function as both a portable media player and as a mass storage device. In other embodiments, the computing device 100 is a digital audio player such as those manufactured by, for example and without limitation, Samsung Electronics America of Ridgefield Park, N.J., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Google/Motorola line of combination digital audio players and mobile phones. In another of these embodiments, the computing device 100 is a device in the IPHONE smartphone line of devices manufactured by Apple Inc. In still another of these embodiments, the computing device 100 is a device executing the ANDROID open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 100 is a tablet device such as, for example and without limitation, the IPAD line of devices manufactured by Apple Inc.; the PLAYBOOK manufactured by Research In Motion; the CRUZ line of devices manufactured by Velocity Micro, Inc. of Richmond, Va.; the FOLIO and THRIVE line of devices manufactured by Toshiba America Information Systems, Inc. of Irvine, Calif.; the GALAXY line of devices manufactured by Samsung; the HP SLATE line of devices manufactured by Hewlett-Packard; and the STREAK line of devices manufactured by Dell, Inc. of Round Rock, Tex.

Although the examples described herein relate to documents formatted according to a Portable Document Format (PDF), it will be understood that the methods and systems described herein may be applied to any type or form of document or other electronic file, including, without limitation, documents available for download across a network, e.g., web pages. Document formats for such documents may include, without limitation, Advanced Function Printing (AFP), POSTSCRIPT, Tagged Image File Format (TIFF), Scalable Vector Graphics (SVG), Joint Photographic Experts Group (JPEG), Portable Network Graphics (PNG), Xerox Metacode, or Printer Command Language (PCL). The methods and systems described herein may provide functionality for generating compressed PDFs usable in connection with automatic report generation. Furthermore, although PDFs may commonly be thought of as documents interacted with using applications provided by Adobe Systems Incorporated of San Jose, Calif., one of ordinary skill in the art will understand that there are many alternatives to the software provided by Adobe Systems Incorporated. Additionally, the methods and systems described herein may provide functionality for connecting to any number of third-party systems (e.g., visualization systems, reporting systems, or any type or form of word processing systems) via, for example, an application programming interface (API).

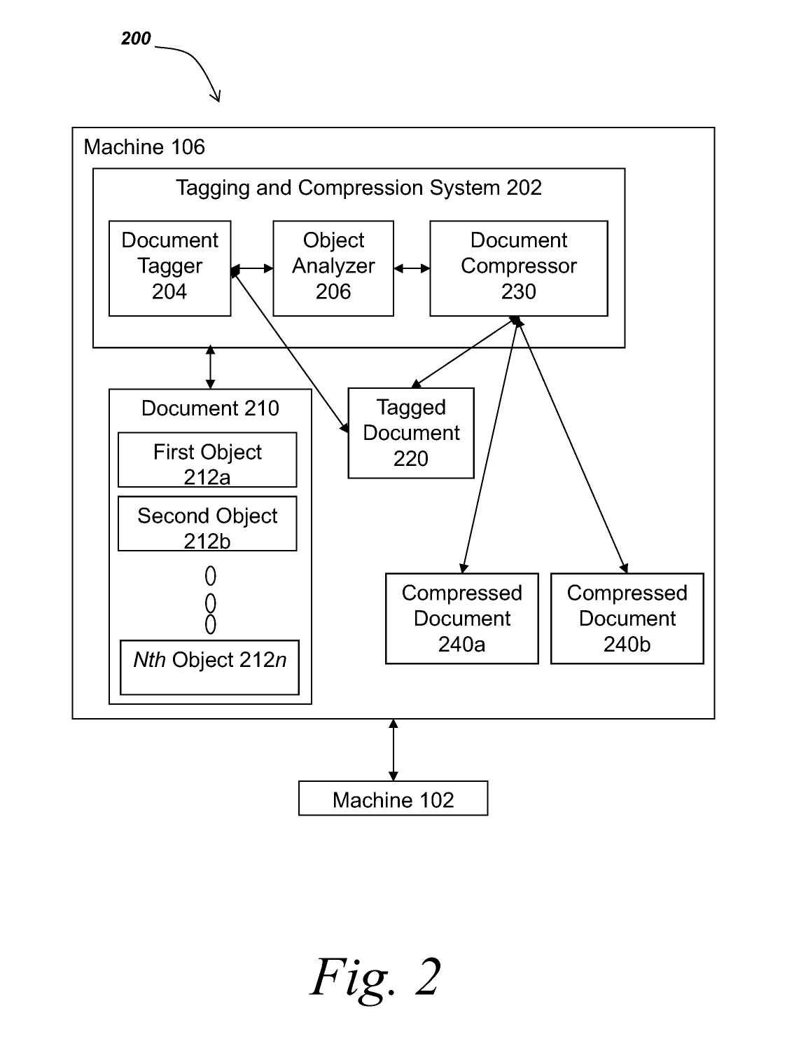

Referring now to FIG. 2, a block diagram depicts one embodiment of a system for generating and compressing tagged documents. In brief overview, the system includes a machine 100, a tagging and compression system 202, a document tagger 204, an object analyzer 206, a document 210, an embedded object 212, a tagged document 220, a document compressor 230, and a compressed document 240. The tagging and compression system 202 may provide the functionality of any and all of the document tagger 204, the object analyzer 206, and the document compressor 230.

In one embodiment, the tagging and compression system 202 is implemented in software. In another embodiment, the tagging and compression system 202 is implemented in hardware.

In one embodiment, the tagging and compression system 202 executes on the machine 100. In another embodiment, the functionality of the tagging and compression system 202 is distributed across a plurality of machines 106a-n.

In one embodiment, the document compressor 230 is implemented in software. In another embodiment, the document compressor 230 is implemented in hardware. The document compressor 230 executes on the machine 100. The document compressor 230 may include the functionality of a PDF writer. The document compressor 230 may include the functionality of a PDF authoring application.

In one embodiment, the object analyzer 206 is implemented in software. In another embodiment, the object analyzer 206 is implemented in hardware. The object analyzer 206 may execute on the machine 100. The document compressor 230 may include the functionality of the object analyzer 206.

In one embodiment, the document 210 is a document formatted according to the Portable Document Format (PDF).

In one embodiment, the objects 212a-n are any form and type of object. In another embodiment, the objects 212a-n are any form and type of PDF object.

In one embodiment, the tagged document 220 includes a tag tree. In another embodiment, the tagged document 220 includes a tag structure of any form or type. In still another embodiment, the tagged document 220 includes a tag structure formatted in accordance with a Document Object Model (DOM) specification. In another embodiment, the tagged document 220 is a document in the eXtensible Markup Language (XML). In yet another embodiment, the tagged document 220 includes at least one XML tag.

In some embodiments, the machine 100 is connected to a client machine 102 (not shown). In one of these embodiments, the tagging and compression system 202 is part of a web-based visualization and analysis environment; for example, the tagging and compression system 202 may be a plug-in, add-on, or other sub-component of standalone or web-based software for generating data visualization objects, images including those data visualization objects, and electronic documents (including, without limitation, reports, presentations, and electronic documents generally).

Although for ease of discussion the tagging and compression system 202, the document tagger 204, the object analyzer 206, and the document compressor 230 are described as separate modules, it should be understood that this does not restrict the architecture to a particular implementation. For instance, these modules may be encompassed by a single circuit or software function; alternatively, they may be distributed across a plurality of machines 100.

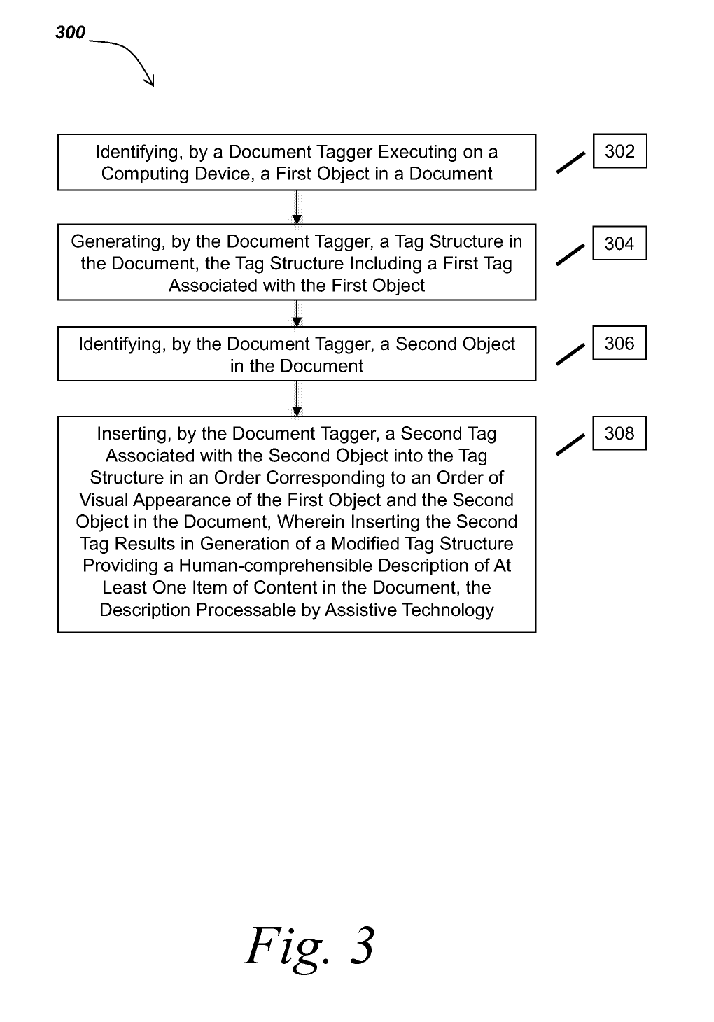

Referring now to FIG. 3, and in connection with FIG. 2, a flow diagram depicts one embodiment of a method 300 for generating a document tag structure providing a human-comprehensible description of document contents, the description processable by assistive technology. In brief overview, the method 300 includes identifying, by a document tagger executing on a computing device, a first object in a document (302). The method 300 includes generating, by the document tagger, a tag structure in the document, the tag structure including a first tag associated with the first object (304). The method 300 includes identifying, by the document tagger, a second object in the document (306). The method 300 includes inserting, by the document tagger, a second tag associated with the second object into the tag structure in an order corresponding to an order of visual appearance of the first object and the second object in the document, wherein inserting the second tag results in generation of a modified tag structure providing a human-comprehensible description of at least one item of content in the document, the description processable by assistive technology (308).

In some embodiments, the document tagger 204 modifies the document 210. In one of these embodiments, the document 210 has previously been tagged, either by a human user or by an automated process. In another of these embodiments, the document tagger 204 removes a previously inserted tag from a previously inserted tag structure in the document 210. For example, the document tagger 204 may remove a tag that does not provide accessibility descriptions. As another example, the document tagger 204 may remove a tag that includes an instruction to modify a visual representation of text in the document 210 (e.g., modifying a color, font, style, or other presentation attribute of the text). As a further example, the document tagger 204 may access a listing of tags determined to be unnecessary (e.g., optional) for the purposes of generating an accessible document (e.g., a document in compliance with an accessibility standard) and remove any tags from the document 210 that appear on the listing of tags. In some embodiments, the document tagger 204 may make these modifications before proceeding to generate new tags and inserting the generated tags into the pre-existing tag structure. In other embodiments, the document tagger 204 removes the previously inserted tag structure.

Referring now to FIG. 3 in greater detail, and still in connection with FIG. 2, the method 300 includes identifying, by a document tagger executing on a computing device, a first object in a document (302). In one embodiment, the document tagger 204 identifies the first object 212a in the document 210. In another embodiment, the object analyzer 206 analyzes the document 210 to identify the first object 212a. The first object 212 may be a visual element. The first object 212 may be a dynamic image. The first object 212 may be a static image. The first object 212 may be text. The first object 212 may be a PDF object. PDF objects, as will be understood by one of ordinary skill in the art, include a null object, a Boolean object, a string object (e.g., literal strings or hexadecimal strings), numeric objects, name objects, array objects, dictionary objects, and stream objects.

The object analyzer 206 may analyze text included in the document to identify the first object; for example, and without limitation, the object analyzer 204 may analyze a file structure of the document, a header of the document, a body of the document, a table (e.g., a cross-reference table), or other sections of the document that include information regarding objects contained within the document. In some embodiments, an object in the document is preceded by an object identifier. As will be understood by those of ordinary skill in the art, a PDF document may include a file structure identifying how objects in the PDF are stored, accessed, and updated; a document structure indicating how basic object types are used to represent components of the PDF document; and a content stream providing instructions describing the appearance of graphical entities (e.g., pages). In some embodiments, the object analyzer 206 identifies compressed objects within the document by analyzing a filter entry within the stream dictionary of the document; for example, the object analyzer 206 may determine, based on the filter entry, a type of compression applied and determine, based on the filter entry, that the document includes at least one object to which the compression type was applied.

The method 300 includes generating, by the document tagger, a tag structure in the document, the tag structure including a first tag associated with the first object (304). In one embodiment, the document tagger 204 identifies a type of tag structure to generate based on a characteristic of the document 210; for example, the document 210 may include an identification of a version of PDF that the document 210 complies with, and the document tagger 204 may use that version identification to select one of a plurality of tag structures to generate. In another embodiment, the document tagger 204 selects a tag structure that satisfies an accessibility specification. In still another embodiment, the document tagger 204 modifies a previously existing tag structure to generate a tag structure that includes the tag. In some embodiments, the document tagger 204 identifies a tag that should be associated with the object 212, generates the tag, and inserts the tag into the tag structure at the beginning of the tag structure (e.g., where the tag structure is a tree, at the top of the tree). In some embodiments, the document tagger 204 generates the tag structure and inserts a tag in a manner that satisfies a specification for tagging PDFs, such as ISO 32000 and ISO 14289.

The document tagger 204 may generate a tag that satisfies an accessibility requirement (e.g., as specified by an accessibility standard). The document tagger 204 may generate a tag that includes an accessibility description of the at least one object. For example, the document tagger 204 may generate a tag including a text-based description of an object including a data visualization. In some embodiments, the document tagger 204 is in communication with an automatic accessibility description generator (not shown) and receives information to include in the text from the generator. In some embodiments, a generated tag including an accessibility description includes a summary of objects embedded in the document 210. In one embodiment, by way of example, the summary may include text from a header, a total number of image objects or data visualization objects, a summary of a number of text paragraphs, or any other type or form of summary that provides a user with additional information regarding the contents of the document.

The method 300 includes identifying, by the document tagger, a second object in the document (306). In one embodiment, the document tagger 204 identifies the second object 212b as described above in connection with (302).

The method 300 includes inserting, by the document tagger, a second tag associated with the second object into the tag structure in an order corresponding to an order of visual appearance of the first object and the second object in the document, wherein inserting the second tag results in generation of a modified tag structure providing a human-comprehensible description of at least one item of content in the document, the description processable by assistive technology (308). In one embodiment, the document tagger 204 inserts the second tag into the tag structure as described in connection with (304). In another embodiment, the document tagger 204 inserts the second tag at a position in the tag structure that is after a position of the first tag, if the second object 212b in the document 210 visually appears after a display of the first object 212a.

In one embodiment, the document tagger 204 generates a tag table including at least one tag identification number identifying a tag in the tag structure. In one embodiment, the tag table may be a hash table.

The document tagger 204 may insert tag metadata into the tag structure. Tag metadata as used herein may refer to standard structure types associated with a tag. Tag metadata as used herein may also refer to tag attributes of a tag. Therefore, in some embodiments, generating the tag structure includes inserting into the tag structure a tag associated with a standard structure type. Generating the tag structure may also include inserting into the tag structure a tag attribute associated with a tag. In one embodiment, the document tagger 204 generates tag metadata including a page number. In another embodiment, the document tagger 204 generates tag metadata including a unique tag identification number. In still another embodiment, the document tagger 204 generates tag metadata including a coordinate pair identifying a location on a page in the first document at which the at least one object 212 is embedded.

In some embodiments, the document tagger 204 applies a compression algorithm to the modified document 210. In other embodiments, space is saved by inserting newly generated tags into a pre-existing tag structure. In particular, in an embodiment in which the newly generated tags are accessibility tags, space is saved by combining the accessibility tags with the pre-existing tag structure instead of creating a separate tag structure for accessibility tags.

As another example of improvements to documents 210 provided by the system 200, the use of the tags generated as described herein allows for the creation of reflowable PDF files for viewing on handheld devices and other media. As another example, certain data objects may be hidden (e.g., through the use of an “Artifact” tag that indicates that the associated object should not be displayed). As another example, objects may be removed (such as ornate graphic letters) or added (such as titles) or reordered. Text formatting information may be provided. Examples of tags include tags that indicate, without limitation, at least the following: articles, annotations, bibliographic entries, block quotes, captions, code, division, document, figure, form, formula, headings, index, label, link, list, list item, list item body, non-structural element, note, paragraph, part, private element, quote, reference, section, span, table, table data cell, table body row group, table foot row group, table header cell, table header row group, table of contents, table of contents item, and table row.

In some embodiments, the tags generated by the system 200 improve a document 210. In contrast to conventional systems, which use PDF tag structures as instructions sets providing instructions for a machine to generate a visual representation of one or more objects embedded in the PDF document, the system 200 may modify or replace a tag structure with one that complies with PDF specifications (and thus remains syntactically valid) but which also describes the component objects in a way that is comprehensible for human users. Specifically, in one of these embodiments, by removing certain tags from a pre-existing tag structure (e.g., those that a human user might characterize as “superfluous” for the purpose of understanding the contents of a document) and by inserting tags that are in an order based on visual appearance, the system 200 may allow a human user that later reads the tag structure—or has an assistive technology device, such as a screen reader, do so on her behalf—to receive a more logical description of the contents of the document (e.g., a more cognitively valid, human-comprehensible description). Additionally, the tags that are added may include a high level description of the contents of the document. In some embodiments, while the tag structure may include the data that a first machine needs to properly render the objects embedded in the document (e.g., a listing, in order, of fonts, indentation, paragraphs, lists, etc.), the tag structure may include that data in an order that provides a human user (directly or indirectly via a screen reader) with more value in understanding the document (e.g., “There is an executive summary, there are three data visualization objects and two images, followed by a detailed memorandum six paragraphs long.”).

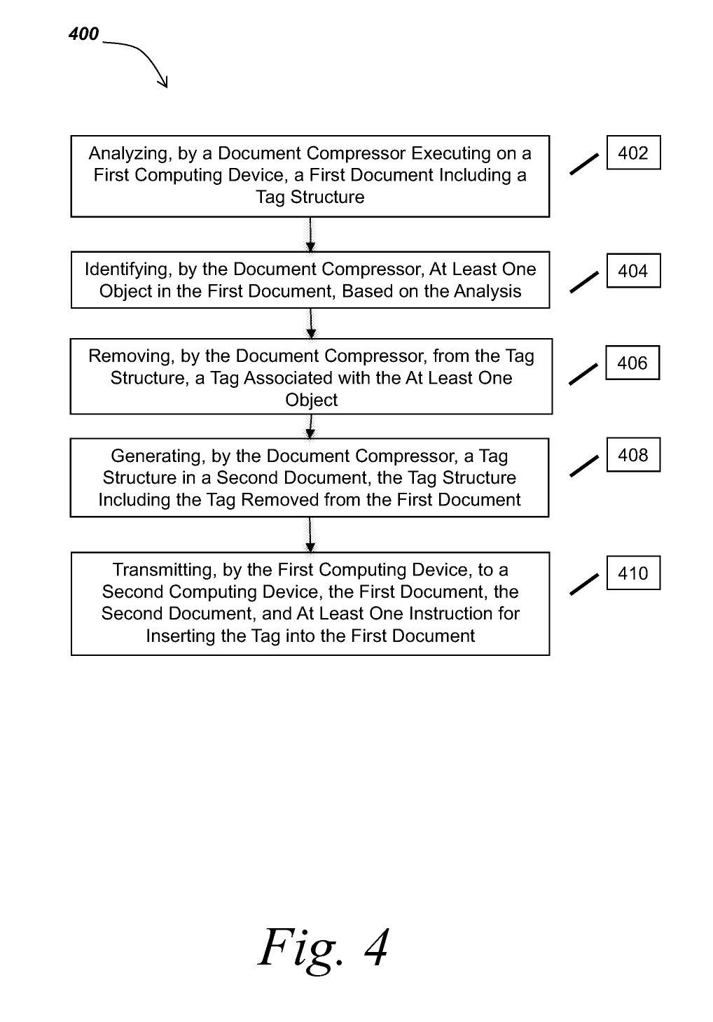

Referring now to FIG. 4, a flow diagram depicts one embodiment of a method for compressing a tagged document. The method 400 includes analyzing, by a document compressor executing on a first computing device, a first document including a tag structure (402). The method 400 includes identifying, by the document compressor, at least one object in the first document, based on the analysis (404). The method 400 includes removing, by the document compressor, from the tag structure, a tag associated with the at least one object (406). The method 400 includes generating, by the document compressor, a tag structure in a second document, the tag structure including the tag removed from the first document (408). The method 400 includes transmitting, by the first computing device, to a second computing device, the first document, the second document, and at least one instruction for inserting the tag into the first document (410).

The method 400 includes analyzing, by a document compressor executing on a first computing device, a first document including a tag structure (402). In one embodiment, the document compressor 230 receives a tagged document 220. The document compressor 230 may receive the tagged document 220 from the document tagger 204. The document compressor 230 may retrieve the tagged document 220 from a database accessible to the machine 106 (not shown). The document compressor 230 may receive a document 210 that was previously tagged (i.e., independently of the document tagger 204). In one embodiment, the document compressor 230 includes functionality for analyzing the tagged document 220. In another embodiment, the document compressor 230 is in communication with the object analyzer 206, which analyzes the tagged document 220.

The method 400 includes identifying, by the document compressor, at least one object in the first document, based on the analysis (404). In one embodiment, the document compressor 230 identifies the object in the tagged document 220 as described above in connection with FIG. 3 (302). In another embodiment, the object analyzer 206 identifies the object in the tagged document 220 as described above in connection with FIG. 3 (302).

The method 400 includes removing, by the document compressor, from the tag structure, a tag associated with the at least one object (406). In one embodiment, the document compressor 230 replaces the tag with a placeholder. For example, the placeholder may be a tag identification number that is associated with the tag. In some embodiments, the same tag appears multiple times throughout the document; the document compressor 230 may remove each instance of the tag, replacing each instance with the same placeholder.

In some embodiments, the document compressor 230 is not limited to removing tags but may also remove the underlying objects; for example, an image of a logo embedded within a header of every page in a 200-page report may be replaced with 200 instances of a text-based placeholder (e.g., an object identifier) and the report may be transmitted to another computer with only a single instance of the image. Therefore, in some embodiments, the method 400 includes removing, by the document compressor 230, from the first document, the at least one object as well as the tag, and replacing each instance of the at least one object with placeholders.

The method 400 includes generating, by the document compressor, a tag structure in a second document, the tag structure including the tag removed from the first document (408). In some embodiments, by separating the tag from the first document containing the tag structure, the document compressor 230 makes the first document more amenable to compression. In one of these embodiments, the first document remains a valid PDF, even after the removal of the tag. As indicated above, the method 400 may include removing objects as well as tags; therefore, the method 400 may also include including in the second document the at least one object associated with the removed tag.

As will be understood by one of ordinary skill in the art, PDF tags may contain a large quantity of data and removal of the tags may make the underlying PDF into a substantially smaller file. By way of example, and as will be understood by one of ordinary skill in the art, PDF tags may include accessibility descriptions that provide each of a variety of aspects of an image, may include detailed descriptions of complex data visualizations, may include (for example) details of rows, columns, tables, as well as accompanying calculations regarding mathematical or statistical properties of underlying data, potentially wrapping each sub-component of an object (e.g., each cell in a table) in a separate and comprehensive description. As will be understood by one of ordinary skill in the art, accessibility descriptions may easily result in documents that are several times larger than the original. By removing the tags and objects that contribute to the overall file size, the document compressor 230 may generate files that are substantially reduced in size.

In one embodiment, the document compressor 230 applies a first compression algorithm to the first document. In another embodiment, the document compressor 230 applies a first compression algorithm to the second document. In some embodiments, the document compressor 230 applies the same compression algorithm to both the first document and the second document. In other embodiments, the document compressor 230 applies different compression algorithms to the first document and the second document. By way of example, some compression algorithms may be better suited to compressing text-based documents while others may be better suited to compressing documents with embedded objects; by applying an algorithm best suited for compressing a type of content within each of the two documents, the document compressor 230 improves compression of both documents. The document compressor 230 may apply a compression algorithm to either of the first document and the second document. The document compressor 230 may apply a compression algorithm to both the first document and the second document.

The method 400 includes transmitting, by the first computing device, to a second computing device, the first document, the second document, and at least one instruction for inserting the tag into the first document (410). The instruction for inserting the tag into the first document may include instructions for decompressing the first document and the second document. The instruction may include the tag identification number that is associated with the tag and included in the placeholder for the tag within the first document. In some embodiments, the second computing device executes an application that can process the at least one instruction to reassemble the tagged document 220. For example, the application may store the documents and the at least one instruction according to the manner in which table-based compression systems do; for example, stored based on an order of the data such as Huffman encoding or support vector machines and it may do this via hashing. For example, the application (not shown) may include functionality to process the at least one instruction, retrieve a tag identification number from the at least one instruction, identify the tag associated with the tag identification number and located within the second document, extract the identified tag, and paste the extracted tag into the first document at each location at which the tag identification number is included in a placeholder.

In some embodiments, therefore, the methods and systems described herein provide functionality for generating and compressing tagged documents.

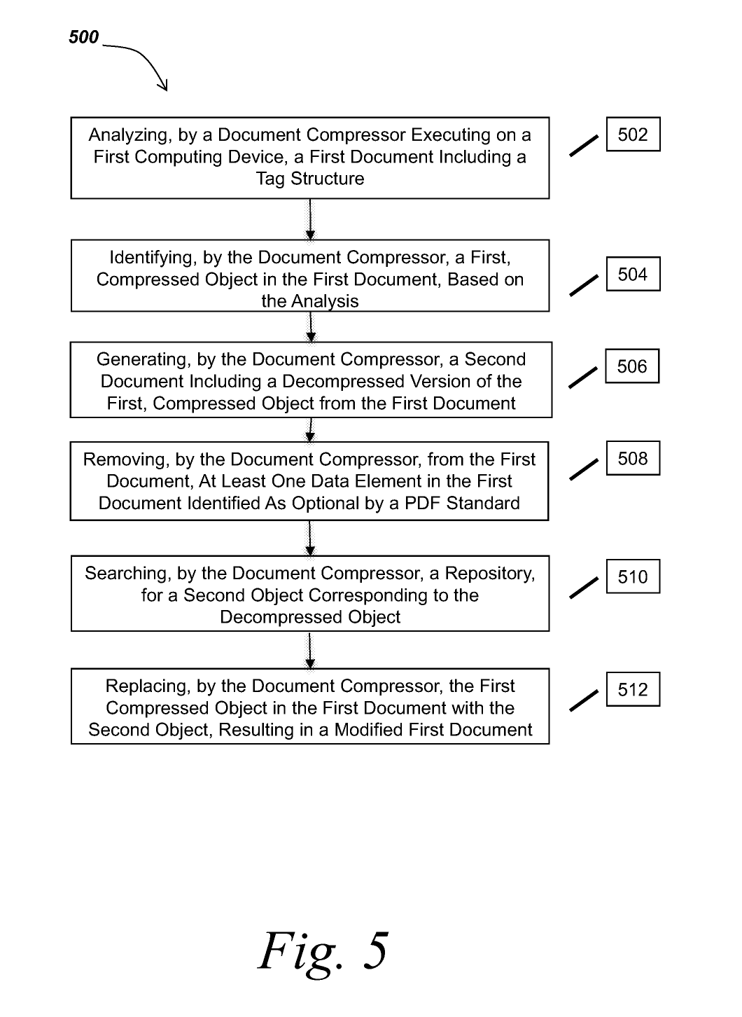

Referring now to FIG. 5, a method 500 for optimizing a tagged document for compliance with at least one of a portable document format (PDF) standard and an accessibility standard includes analyzing, by a document compressor executing on a first computing device, a first document including a tag structure (502). The method 500 includes identifying, by the document compressor, a first, compressed object in the first document, based on the analysis (504). The method 500 includes generating, by the document compressor, a second document including a decompressed version of the first, compressed object from the first document (506). The method 500 includes removing, by the document compressor, from the first document, at least one data element in the first document identified as optional by a PDF standard (508). The method 500 includes searching, by the document compressor, a repository, for a second object corresponding to the decompressed object (510). The method 500 includes replacing, by the document compressor, the first, compressed object in the first document with the second object, resulting in a modified first document (512). In one embodiment, the document compressor applies a first compression algorithm to the modified first document. In another embodiment, the document compressor generates a modified first document that is processable by assistive technology.

Referring now to FIG. 5 in greater detail, and in connection with FIGS. 2-4 above, a method 500 for optimizing a tagged document for compliance with at least one of a portable document format (PDF) standard and an accessibility standard includes analyzing, by a document compressor executing on a first computing device, a first document including a tag structure (502). In one embodiment, the document compressor 230 analyzes the first document as described above in connection with FIG. 4.

In some embodiments, the document compressor 230 removes the tag structure from the first document and replaces it with an optimized tag structure (e.g., optimized for compliance with either PDF standards or accessibility standards or both), as described above.

The method 500 includes identifying, by the document compressor, a first, compressed object in the first document, based on the analysis (504). In one embodiment, the document compressor 230 identifies the first, compressed object as described in FIG. 3 above in connection with identifying tags.

In some embodiments, the document compressor 230 adds tags corresponding to identified objects. For example, use of a tag structure may be optional in generating PDFs (e.g., as an optional, stylized method of providing structure to a page) and therefore the first document may not have previously had a tag structure generated. Tags may be instances of tags as defined in one or more PDF standards (e.g., ISO32000).

The method 500 includes generating, by the document compressor, a second document including a decompressed version of the first, compressed object from the first document (506). The second document may be referred to as a buffer document. The second document may be a PDF document.

The method 500 includes removing, by the document compressor, from the first document, at least one data element in the first document identified as optional by a PDF standard (508). Data elements may include, without limitation interactivity components, tags, repeating vector objects, unnecessary metadata and print setting instructions, scripts, comments, and user data. In some embodiments, by eliminating optional information, the system focuses on providing a semantic approach to tagging a document using rules for creating an accessible structure. In one of these embodiments, by way of example, and without limitation, the modified document will only include tags for the purpose of accessibility with no corresponding definitions or attributes, or even unnecessary user data, and can be kept as small as possible. The document compressor 230 may remove the at least one data element as described in FIG. 4 above in connection with removing tags. In some embodiments, a PDF document processed by a third-party authoring software may include information specific to the authoring software; however, such information may be deemed optional and may be unnecessarily increasing the size of the PDF document. As an example, third-party authoring software may be configured to include one or more data elements that a PDF standard has specified are optional in order to provide additional functionality to users; however, if the optional data elements are not needed by the users, the optional data elements unnecessarily increase the size of the PDF document. Therefore, in some embodiments, removing such data elements from the document results in an optimized PDF that is easier to compress and transmit between computing devices.

In some embodiments, in addition to, or instead of, removing data elements, the system 200 may correct wrong or missing tags. For example, the first document may be a PDF document for which no optical character recognition process was previously applied and therefore the first document may be missing tags that would have been generated as a result of that process.

The method 500 includes searching, by the document compressor, a repository, for a second object corresponding to the decompressed object (510). In one embodiment, the repository is a database. In some embodiments, the repository is populated with a set of common PDF objects (e.g., PDF objects found in a threshold number of PDF documents). In other embodiments, as the system 200 optimizes objects within PDFs, the system 200 stores the optimized objects in the repository for subsequent reuse. The system 200 may store all optimized objects; alternatively, the system 200 may store optimized objects after having determined that the objects appeared in a threshold number of PDF documents (e.g., a configurable amount specified by a user or programmatically).

In some embodiments, to search for a second object corresponding to the decompressed object, the document compressor leverages demarcations within the PDF document (e.g., leveraging the fact that objects in a PDF may be demarcated using specific characters that are used to identify them). This provides a method of distinguishing what type of PDF object is present. There are also methods of interpreting hidden content in the PDF, line and word breaks, and special character designations. Depending on the type of PDF object it is, specific information about it might also be available. For example, marked content uses property lists to provide more information about it that is useful for determining its purpose. Based on a pre-determined codex of rules, the system 200 may determine the appropriate object. By way of example, the system 200 may apply pattern-matching search techniques.

If the document compressor 230 does not identify a matching second object, the document compressor 230 may optimize the decompressed object and store the optimized object in the repository. In one embodiment, the document compressor 230 may optimize the decompressed object by identifying references to attributes that define the object but which duplicate information already provided elsewhere in the document. In another embodiment, the document compressor 230 may optimize the decompressed object by removing optional information. For example, the document compressor 230 may sanitize an object to only include information necessary for the object to exist either as a direct object or an indirect object. In still another embodiment, the document compressor 230 compresses the object; for example, the document compressor 230 may compress the object at the object level (instead of, for example, at the document level) using a compression algorithm separate from any compression algorithms applied to either page content or logical structure.

The method 500 includes replacing, by the document compressor, the first, compressed object in the first document with the second object, resulting in a modified first document (512).

In one embodiment, the document compressor 230 applies a first compression algorithm to the modified first document. The document compressor 230 may apply the first compression algorithm as described above in connection with FIG. 4. In another embodiment, the document compressor 230 generates a modified first document that is processable by assistive technology.

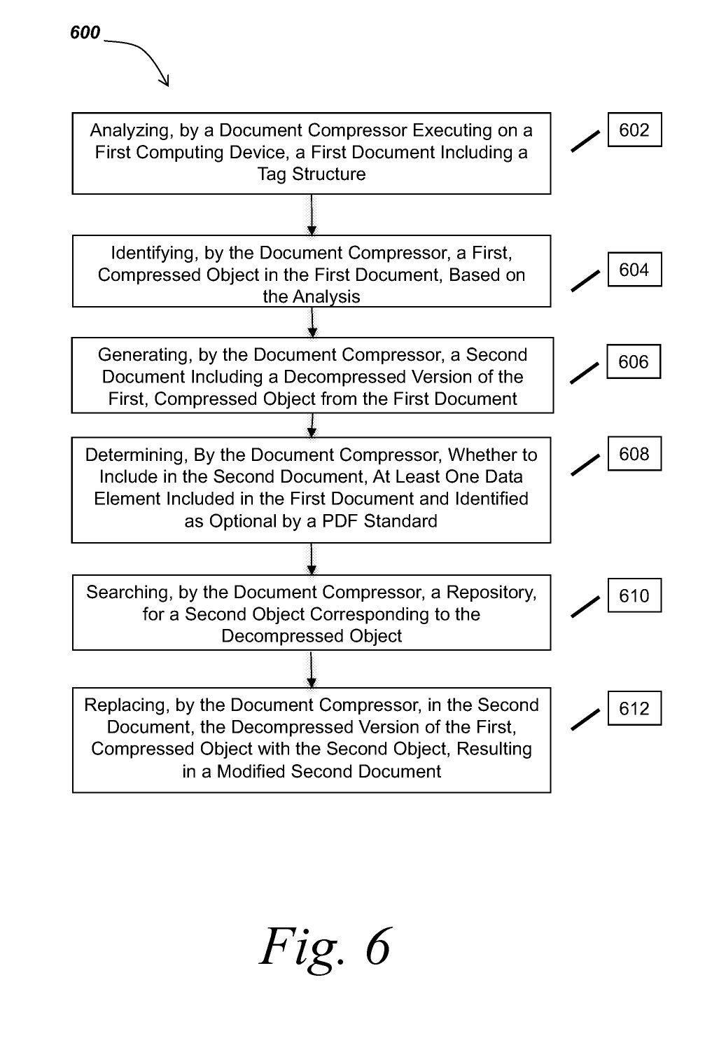

Referring now to FIG. 6, a method 600 for optimizing a tagged document for compliance with at least one of a portable document format (PDF) standard and an accessibility standard includes analyzing, by a document compressor executing on a first computing device, a first document including a tag structure (602). The method 600 includes identifying, by the document compressor, a first, compressed object in the first document, based on the analysis (604). The method 600 includes generating, by the document compressor, a second document including a decompressed version of the first, compressed object from the first document (606). The method 600 includes determining, by the document compressor, whether to include in the second document at least one data element included in the first document and identified as optional by a PDF standard (608). The method 600 includes searching, by the document compressor, a repository, for a second object corresponding to the decompressed object (610). The method 600 includes replacing, by the document compressor, in the second document, the decompressed version of the first, compressed object with the second object, resulting in a modified second document (612). In one embodiment, the document compressor applies a first compression algorithm to the modified second document. In another embodiment, the document compressor generates a modified second document that is processable by assistive technology.

Referring now to FIG. 6 in greater detail and in connection with FIGS. 2-5, a method 600 for optimizing a tagged document for compliance with at least one of a portable document format (PDF) standard and an accessibility standard includes analyzing, by a document compressor executing on a first computing device, a first document including a tag structure (602). The document compressor may analyze the first document as described above in connection with FIG. 5.

The method 600 includes identifying, by the document compressor, a first, compressed object in the first document, based on the analysis (604). The document compressor may identify the first, compressed object in the first document as described above in connection with FIG. 5.

The method 600 includes generating, by the document compressor, a second document including a decompressed version of the first, compressed object from the first document (606). The document compressor may generate the second document as described above in connection with FIG. 5.

The method 600 includes determining, by the document compressor, whether to include in the second document at least one data element included in the first document and identified as optional by a PDF standard (608). In some embodiments, the document compressor 230 determine that the at least one data element is optional. In one of these embodiments, the document compressor 230 determines not to include in the second document at least one data element included in the first document.

The method 600 includes searching, by the document compressor, a repository, for a second object corresponding to the decompressed object (610).

The method 600 includes replacing, by the document compressor, in the second document, the decompressed version of the first, compressed object with the second object, resulting in a modified second document (612). The document compressor 230 may replace the decompressed version of the first, compressed object in the second document as described in FIG. 5 above in connection with replacing the first, compressed object in the first document.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Having described certain embodiments of methods and systems for generating and compressing tagged documents, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for generating a document tag structure providing a human-comprehensible description of document contents, the description processable by assistive technology, the method comprising:
identifying, by a document tagger executing on a computing device, a first object in a document;
generating, by the document tagger, a tag structure in the document, the tag structure including a first tag associated with the first object;
identifying, by the document tagger, a second object in the document; and
inserting, by the document tagger, a second tag associated with the second object into the tag structure in an order corresponding to an order of visual appearance of the first object and the second object in the document,
wherein inserting the second tag results in generation of a modified tag structure providing a human-comprehensible description of at least one item of content in the document, the description processable by assistive technology.

2. The method of claim 1 further comprising modifying, by the document tagger, the document.

3. The method of claim 2, wherein modifying further comprises removing, by the document tagger, from the document, a previously inserted tag.

4. The method of claim 2, wherein modifying further comprises removing, by the document tagger, from the document, a previously inserted tag structure.

5. The method of claim 1, wherein identifying the first object further comprises identifying a visual element.

6. The method of claim 1, wherein identifying the first object further comprises identifying a Portable Document Format (PDF) object.

7. The method of claim 1, wherein generating the tag structure further comprises generating a tag that includes an accessibility description of the at least one object.

8. The method of claim 1, wherein generating the tag structure further comprises inserting a tag associated with a standard structure type into the tag structure.

9. The method of claim 8, wherein standard structure type further comprises a page number.

10. The method of claim 8, wherein standard structure type further comprises a coordinate pair identifying a location on a page in the first document at which the at least one object is embedded.

11. The method of claim 8, wherein a tag further comprises a unique tag identification number.

12. The method of claim 1, wherein generating the tag structure further comprises inserting a tag associated with a tag attribute into the tag structure.

13. The method of claim 1 further comprising applying a compression algorithm to the document.

14. A method for optimizing a tagged document for compliance with at least one of a portable document format (PDF) standard and an accessibility standard, the method comprising:
analyzing, by a document compressor executing on a first computing device, a first document including a tag structure;
identifying, by the document compressor, a first, compressed object in the first document, based on the analysis;
generating, by the document compressor, a second document including a decompressed version of the first, compressed object from the first document;
removing, by the document compressor, from the first document, at least one data element in the first document identified as optional by a PDF standard;
searching, by the document compressor, a repository, for a second object corresponding to the decompressed object; and
replacing, by the document compressor, the first, compressed object in the first document with the second object, resulting in a modified first document.

15. The method of claim 14 further comprising applying, by the document compressor, a first compression algorithm to the modified first document.

16. The method of claim 14 further comprises generating, by the document compressor, a modified first document that is processable by assistive technology.

17. A method for optimizing a tagged document for compliance with at least one of a portable document format (PDF) standard and an accessibility standard, the method comprising:
analyzing, by a document compressor executing on a first computing device, a first document including a tag structure;
identifying, by the document compressor, a first, compressed object in the first document, based on the analysis;
generating, by the document compressor, a second document including a decompressed version of the first, compressed object from the first document;
determining, by the document compressor, whether to include in the second document, at least one data element included in the first document and identified as optional by a PDF standard;
searching, by the document compressor, a repository, for a second object corresponding to the decompressed object; and
replacing, by the document compressor, in the second document, the decompressed version of the first, compressed object with the second object, resulting in a modified second document.

18. The method of claim 17 further comprising applying, by the document compressor, a first compression algorithm to the modified second document.

19. The method of claim 17, wherein determining further comprises determining, by the document compressor, not to include in the second document, at least one data element included in the first document and identified as optional by a PDF standard.

20. The method of claim 17 further comprises generating, by the document compressor, a modified first document that is processable by an assistive technology.
